(19) United States
(12) Patent Application Publication
(10) Pub. No.: US 2025/0203341 A1
(43) Pub. Date: Jun. 19, 2025

(54) COORDINATED ROAM POINT NEGOTIATION FOR MULTI-LINK DEVICES

(71) Applicant: Cisco Technology, Inc., San Jose, CA (US)

(72) Inventors: Malcolm M. SMITH, Richardson, TX (US); Brian D. HART, Sunnyvale, CA (US); Indermeet S. GANDHI, San Jose, CA (US); Binita GUPTA, San Diego, CA (US); Jerome HENRY, Pittsboro, NC (US)

(21) Appl. No.: 18/611,268

(22) Filed: Mar. 20, 2024

Related U.S. Application Data
(60) Provisional application No. 63/612,286, filed on Dec. 19, 2023.

(51) Int. Cl. H04W 8/14

(52) U.S. Cl. CPC H04W 8/14

(57) ABSTRACT

Techniques for transitioning one or more links for a multi-link device (MLD). These techniques include identifying a negotiated roam point for one or more links of a wireless station (STA) MLD to roam from a source wireless access point (AP) MLD to a target AP. The techniques further include coordinating roaming for the one or more links of the STA MLD from the source AP MLD to the target AP, based on the negotiated roam point. This includes preparing, prior to the negotiated roam point, to transition traffic for the one or more links from the source AP MLD to the target AP, and transitioning the one or more links of the STA MLD from the source AP MLD to the target AP using the negotiated roam point.

### CROSS-REFERENCE TO RELATED APPLICATIONS

This application claims benefit of co-pending U.S. provisional patent application Ser. No. 63/612,286, filed on Dec. 19, 2023. The aforementioned related patent application is herein incorporated by reference in its entirety.

### TECHNICAL FIELD

Embodiments presented in this disclosure generally relate to wireless communication. More specifically, embodiments disclosed herein relate to roaming for devices in wireless communications.

### BACKGROUND

In next generation Wi-Fi networks, multi-link operation (MLO) with multi-link devices (MLDs) allows non wireless access point (non-AP) wireless stations (STAs) to connect to multiple APs simultaneously, for benefits like higher throughput and reliability. When roaming between APs, techniques like make-before-break-roaming (MBBR) can maintain connectivity by adding the target AP before removing the serving AP. However, optimally negotiating the roam point between the STA and AP is challenging.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless networking environment for coordinated roaming for MLDs, according to one embodiment.

FIG. 2 illustrates block diagrams for an AP and an STA, according to one embodiment.

FIG. 3 is a flowchart illustrating AP initiated coordinated roaming for MLDs, according to one embodiment.

FIG. 4 is a flowchart illustrating an AP MLD determining a roam point, according to one embodiment.

FIG. 5 is a flowchart illustrating non-AP STA initiated coordinated roaming for MLDs, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments include a method. The method includes identifying a negotiated roam point for one or more links of a wireless station (STA) multi-link device (MLD) to roam from a source wireless access point (AP) MLD to a target AP. The method further includes coordinating roaming for the one or more links of the STA MLD from the source AP MLD to the target AP, based on the negotiated roam point. This includes preparing, prior to the negotiated roam point, to transition traffic for the one or more links from the source AP MLD to the target AP, and transitioning the one or more links of the STA MLD from the source AP MLD to the target AP using the negotiated roam point.

Embodiments further include a system, including one or more processors and one or more memories storing a program, which, when executed on any combination of the one or more processors, performs operations. The operations include identifying a negotiated roam point for one or more links of a wireless station (STA) multi-link device (MLD) to roam from a source wireless access point (AP) MLD to a target AP. The operations further include coordinating roaming for the one or more links of the STA MLD from the source AP MLD to the target AP, based on the negotiated roam point. This includes preparing, prior to the negotiated roam point, to transition traffic for the one or more links from the source AP MLD to the target AP, and transitioning the one or more links of the STA MLD from the source AP MLD to the target AP using the negotiated roam point.

Embodiments further include a non-transitory computer-readable medium containing computer program code that, when executed by operation of one or more computer processors, performs operations. The operations include identifying a negotiated roam point for one or more links of a wireless station (STA) multi-link device (MLD) to roam from a source wireless access point (AP) MLD to a target AP. The operations further include coordinating roaming for the one or more links of the STA MLD from the source AP MLD to the target AP, based on the negotiated roam point. This includes preparing, prior to the negotiated roam point, to transition traffic for the one or more links from the source AP MLD to the target AP, and transitioning the one or more links of the STA MLD from the source AP MLD to the target AP using the negotiated roam point.

### EXAMPLE EMBODIMENTS

As discussed above, roaming negotiation is a challenging problem, particularly for MLDs. For example, an STA can independently decide when to switch reception or transmission from a source AP to a target AP. This is generally a client-centric approach, but it provides limited control to the AP over managing roam transitions. This may not be preferred because the AP typically has better knowledge of network conditions than the roaming STA, allowing the AP to optimize the roam point based on application requirements.

In another approach, APs exchange buffered data at the roam point. But this incurs overhead without STA involvement. Tight coordination between the STA and AP can allow the entities to negotiate an optimal, or preferred, roam point in terms of timing and sequence numbers per traffic identifier (TID). This can provide the AP more control, while allowing the STA to manage the transition across its links. Further, STA MLDs and AP MLDs can cooperatively negotiate the roam point by exchanging proposed timing and parameters.

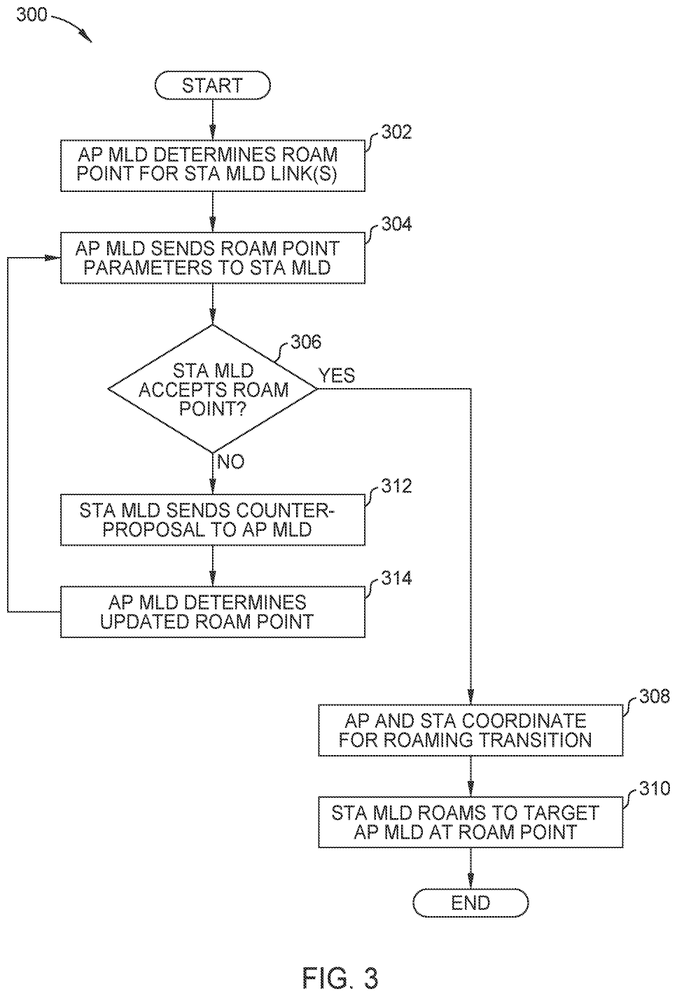

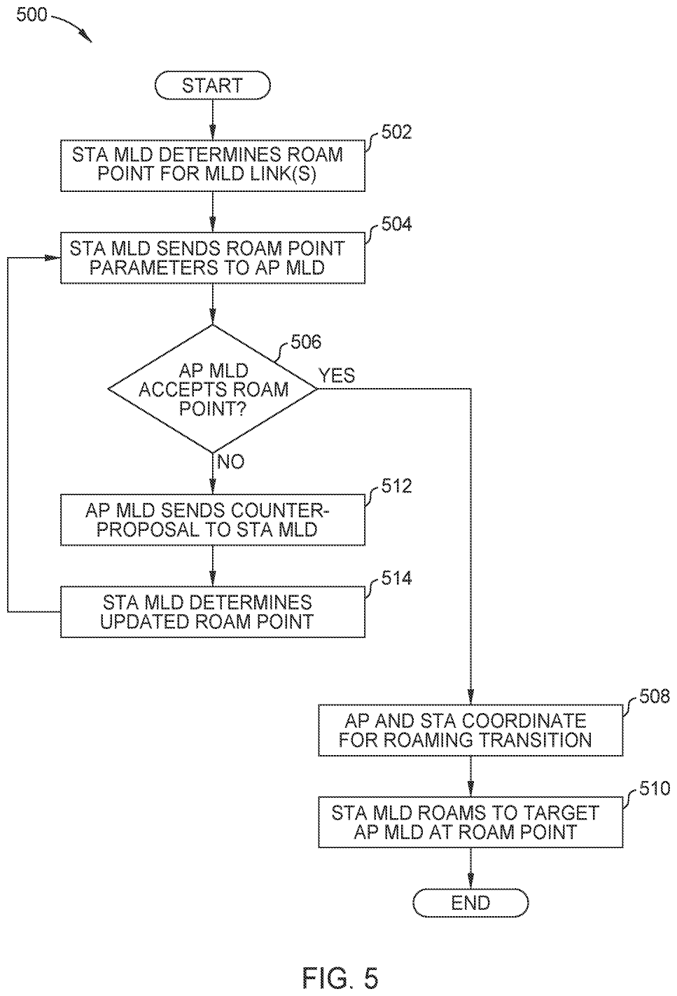

For example, as discussed below in relation to FIG. 3, an AP MLD can initiate roaming coordination by identifying a proposed roam point (e.g., based on network conditions) and proposing the roam point to the STA MLD. The STA MLD can then accept the roam point, and proceed with roaming, or reject the roam point. Further, the STA MLD can provide its own counter-proposal back to the AP MLD (e.g., based on characteristics at the STA), and the AP MLD can use that counter-proposal to identify a different roam point. As another example, as discussed below in relation to FIG. 5, a non-AP STA MLD can initiate roaming coordination, and can exchange roam point proposals with an AP MLD. These are merely examples, and either technique provides a balanced approach that combines the AP's network knowledge with the STA's link management for improved roaming performance.

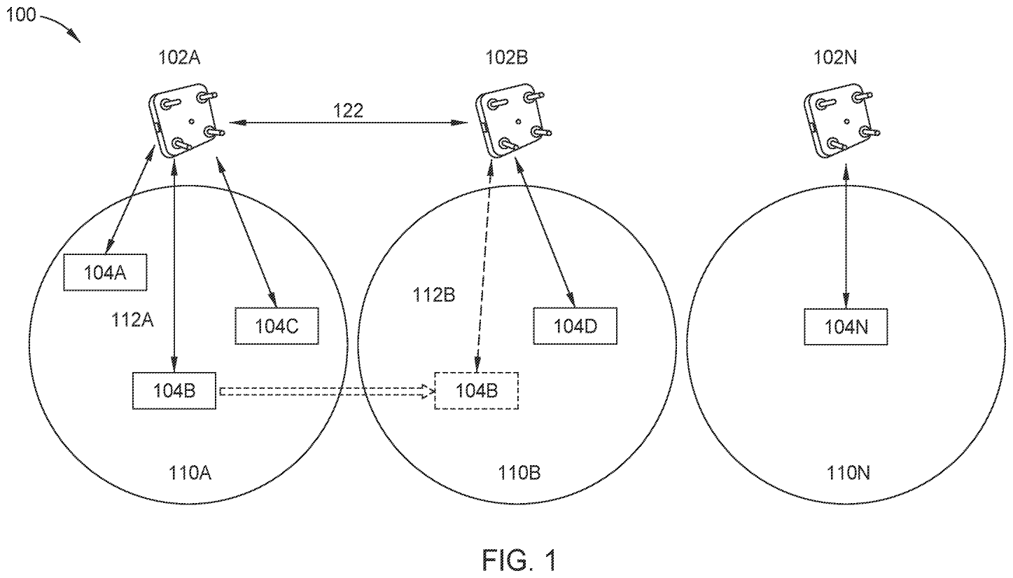

FIG. 1 illustrates a wireless networking environment for coordinated roaming for MLDs, according to one embodiment. In an embodiment, the environment 100 includes a number of APs 102A-N. Each of the APs is associated with one or more STAs 104A-N. The APs 102A-N are examples of infrastructure entities in the wireless networking environment 100d, but any suitable infrastructure entities can be used. The STAs 104A-N are examples of client entities in the wireless networking environment 100, but any suitable client entities can be used.

For example, the AP 102A has three STAs 104A-C associated as part of a basic service set (BSS) 110A. The AP 102B has the STA 104D associated as part of a BSS 110B. The AP 102N has STA 104N associated as part of a BSS 110N. This is merely an example, and the environment 100 can include any suitable number and configuration of wireless devices. Further, each of the STAs 104A-N can be any suitable wireless device, including a laptop computer, a desktop computer, a smartphone, a tablet, an internet of things (IoT) device, a vehicle, another suitable user device, or a wireless network infrastructure device (e.g., a wireless access point (AP)).

In an embodiment, one or more of the STAs are portable and can roam between AP's 102A-N and BSSs 110A-N. For example, assume the STA 104B is mobile and roams from association with a source AP 102A to association with the target AP 102B. Further, assume that the AP 102A, the AP 102B, and the STA 104B are MLDs (e.g., with dual-link connections) and support “Distributed MLO” or “Extended MLO” or “MLO++” capability (e.g., with multiple connections, each using one or more links, to multiple devices). For example, the STA 104B can maintain a connection with the AP 102A using one or more links 112A, and can maintain additional connections with other APs.

As discussed further, below, in relation to FIGS. 3-5, in an embodiment the AP 102A, and STA 104B can coordinate and negotiate a roam point for roaming by the STA 104B from the source AP 102A to the target AP 102B. The roam point can be a proposed time (e.g., expressed in timing synchronization function (TSF) time of the current associated AP MLD), sequence number (SN) per TID values at which roaming can happen, any combination thereof, or any other suitable roam point. Further, the roam point can apply to all MLD links for the STA 104B (e.g., all the links 112A), or for a subset of the MLD links (e.g., some, but not all, of the links 112A).

In an embodiment, after the STA 104B and AP 102A have negotiated a roam point, once that roam point is hit roaming is enforced for the STA 104B. As discussed below in relation to FIGS. 3 and 5, the STA 104B, and APs 102A and 102B, can coordinate to transition the transmission and reception of traffic to the target AP 102B at the roam point.

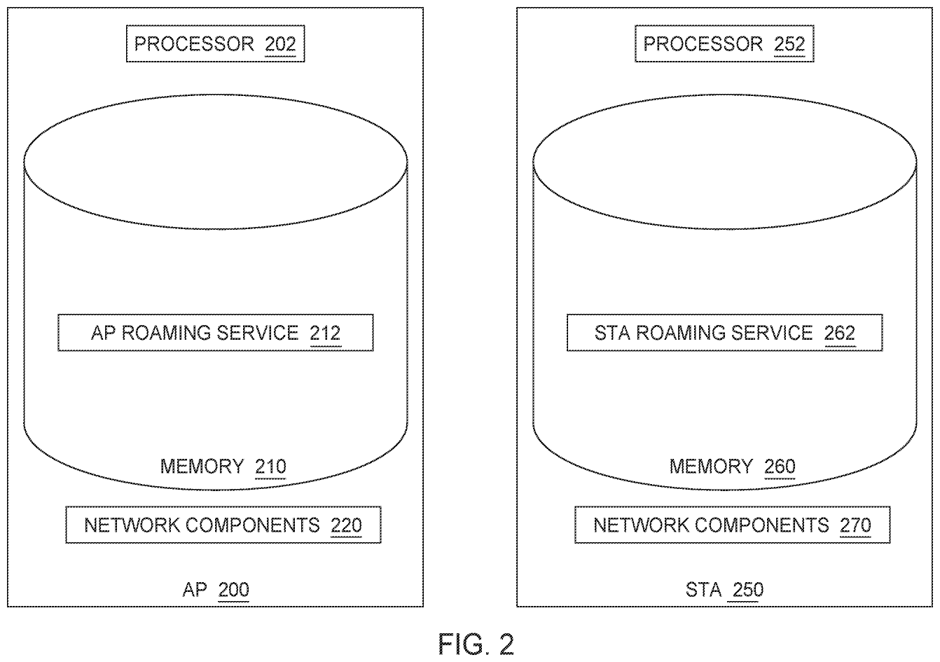

FIG. 2 illustrates block diagrams for an AP 200 and an STA 250, according to one embodiment. In an embodiment, the AP 200 can correspond with any of the APs 102A-N illustrated in FIG. 1, and the STA 250 can correspond with any of the STAs 104A-N illustrated in FIG. 1.

The AP 200 includes a processor 202, a memory 210, and network components 220. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the AP to interface with a communication network, as discussed above in relation to FIG. 1. For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the AP 200. The program code is generally described as various functional “applications” or “modules” within the memory 210, although alternate implementations may have different functions and/or combinations of functions. Within the memory 210, the AP Roaming service 212 facilitates coordinated roaming for MLDs. This is discussed further, below, with regard to FIGS. 3-5. Further, using an AP 200 for coordinated roaming for MLDs is merely one example. Alternatively, or in addition, any other network device (e.g., a wireless local area network (WLAN) controller (WLC) or another network component) can be used.

The STA 250 includes a processor 252, a memory 260, and network components 270. The processor 252 generally retrieves and executes programming instructions stored in the memory 260. The processor 252 is representative of a single CPU, multiple CPUs, a single CPU having multiple processing cores, graphics processing units (GPUs) having multiple execution paths, and the like.

The network components 270 include the components necessary for the STA 250 to interface with a communication network, as discussed above in relation to FIG. 1. For example, the network components 270 can include wired, WiFi, or cellular network interface components and associated software. Although the memory 260 is shown as a single entity, the memory 260 may include one or more memory devices having blocks of memory associated with physical addresses, such as random access memory (RAM), read only memory (ROM), flash memory, or other types of volatile and/or non-volatile memory.

The memory 260 generally includes program code for performing various functions related to use of the STA 250. The program code is generally described as various functional “applications” or “modules” within the memory 260, although alternate implementations may have different functions and/or combinations of functions. Within the memory 260, the STA roaming service 262 facilitates coordinated roaming for MLDs. This is discussed further, below, with regard to FIGS. 3-5. Further, using an STA 250 for coordinated roaming for MLDs is merely one example. Alternatively, or in addition, any other network device (e.g., the AP 200, a WLC or another network component, or any suitable combination) can be used.

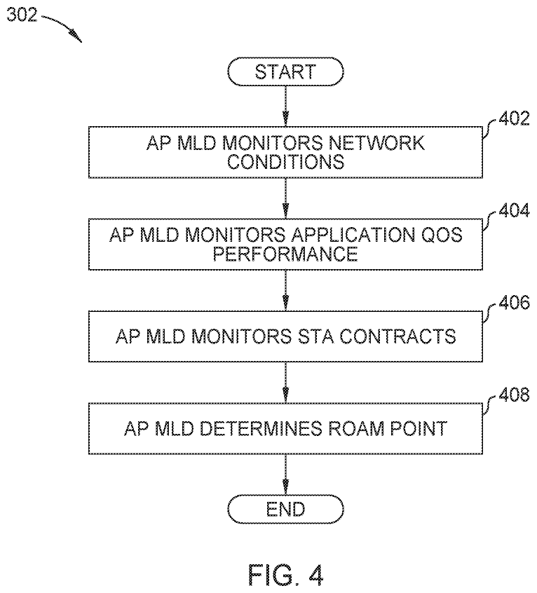

FIG. 3 is a flowchart 300 illustrating AP initiated coordinated roaming for MLDs, according to one embodiment. At block 302, an AP roaming service for an AP MLD (e.g., the AP roaming service 212 illustrated in FIG. 2) determines a roam point for an STA MLD (e.g., a non-AP STA MLD). In an embodiment, the AP roaming service monitors one or more network characteristics to identify a roam point. For example, the AP roaming service can identify a roam point for all the non-AP STA MLD links (e.g., to minimize or reduce handoff disruption). Alternatively, or in addition, the AP roaming service identifies a roam point for a subset of the non-AP STA MLD links (e.g., one or more, but not all, of the non-AP STA MLD links). Additionally, in an embodiment the non-AP STA can roam for all TIDs. Alternatively, or in addition, the non-AP STA can roam for a subset of TIDs (e.g., one or more, but not all, TIDs). This is discussed further, below, with regard to FIG. 4, as well as below with regard to block 310.

While FIG. 3 illustrates an AP MLD initiating roaming coordination, this is merely an example. Alternatively, or in addition, a non-AP STA MLD can initiate roaming coordination. This is discussed further, below, in relation to FIG. 5. Further, any other suitable network component can initiate roaming coordination.

At block 304, the AP roaming service (e.g., the AP roaming service for an AP MLD) sends roam point parameters to the STA MLD (e.g., the non-AP STA MLD). In an embodiment, the AP roaming service sends the roam point parameters using an existing management frame, for example an individual addressed management frame (e.g., a BSS transition management (BTM) request).

Alternatively, or in addition, the AP roaming service sends the roam point parameters using a new management frame (e.g., a new management frame defined for MLD roaming coordination). These are merely examples, and the AP roaming service can send the roam point parameters using any suitable technique. In an embodiment, the management frame specifies one or more target AP MLDs for roaming, one or more criteria leading to the recommendation (e.g., a received signal strength indicator (RSSI), load, or any other suitable criteria), or any other suitable information. These are also merely examples.

Further, in an embodiment, the AP roaming service proposes a duration of negotiation as part of the roam point parameters (e.g., in a management frame). For example, the AP roaming service can propose a duration that defines how long the roaming transition will take. This can include a proposed buffer time for data exchange with the target (e.g., the target AP or target AP MLD), as necessary to meet application needs. In an embodiment, the non-AP STA can include this duration in the roam point negotiation (e.g., as described below in relation to blocks 306 and 312).

At block 306, an STA roaming service for a non-AP STA MLD (e.g., the STA roaming service 262 illustrated in FIG. 2) determines whether to accept the proposed roam point from the AP MLD. In an embodiment, the STA roaming service assesses the proposed roam point against its own link conditions, responsive capabilities (e.g., the ability of the target AP to onboard the STA, based on the conditions set by the STA roaming algorithm), or any other suitable criteria, to determine acceptance. Further, in an embodiment the STA roaming service considers recommendations for target AP MLD(s) and target APs in its determination, if these recommendations are provided by the AP MLD.

In an embodiment, the STA roaming service responds to the AP MLD indicating acceptance or rejection of the proposed roam point. If the STA roaming service accepts the roam point, the STA roaming service responds to the AP MLD indicating acceptance and the flow proceeds to block 308. If the STA roaming service rejects the roam point, the STA roaming service responds to the AP MLD indicating rejection and the flow proceeds to block 312.

At block 308, the AP roaming service and the STA roaming service coordinate the roaming transition. In an embodiment, the AP roaming service and the STA roaming service coordinate by preparing, prior to reaching the negotiated roam point, to transition the transmission and reception of traffic to the target AP MLD or target AP, at the negotiated roam point. For example, if the roam point is a time, the AP roaming service and STA roaming service coordinate the transmission and reception of traffic for the STA MLD from the source (e.g., the source AP MLD) to the target (e.g., a target AP or target AP MLD) at the specified time. As another example, if the roam point is a SN, a defined event (e.g., a TID event), or another suitable roam point, the AP roaming service and STA roaming service coordinate the transmission and reception of traffic for the STA MLD from the source (e.g., the source AP MLD) to the target (e.g., a target AP or target AP MLD) at the specified point.

In an embodiment, the AP roaming service and the STA roaming service coordinate to transfer management state information (e.g., SN or packet number (PN) counters, or future values for SN or PN counters). For example, the AP roaming service and STA roaming service can coordinate to transfer management state information to the target (e.g., the target AP or target AP MLD) following the agreed roam point.

At block 310, the STA MLD roams to the target (e.g., the target AP or AP MLD) at the roam point. As discussed above, the STA MLD transitions from the source AP MLD to the target, at the roam point. In an embodiment, the non-AP STA MLD transmits pending data ahead of the negotiated roam point (e.g., to facilitate roaming). The STA MLD can transition all links, or a subset of links. Further, the STA MLD can transition all TIDs, or a subset of TIDs. The flow the ends.

As discussed above, in an embodiment an AP MLD and STA MLD can coordinate a roam point for all TIDs or a subset of TIDs, and for all links or a subset of links. In an embodiment, the roam point can be implemented independently on a per-TID basis (e.g., to account for different application needs). For example, the AP MLD and STA MLD can coordinate different roam points for different TIDs or different groups of TIDs. Further, the AP MLD, STA MLD, or both, can use TID to link mapping to constrain traffic on each link (e.g., constrain one or more TIDs or groups of TIDs to a give link).

Returning to block 312, if the STA roaming service rejects to the proposed roam point, in an embodiment the STA roaming service sends a counter proposal to the AP MLD. For example, the STA roaming service can use its link condition and roaming capabilities to modify the proposed roam point. The STA roaming service can then send the counter proposal to the AP MLD.

At block 314, the AP roaming service (e.g., the AP roaming service at the AP MLD) determines an updated roam point. For example, the AP roaming service can use the counter-proposal from the STA roaming service to determine an updated roam point. The updated roam point can include any suitable roam point information, including a time, SN, event, one or more target AP MLDs for roaming, one or more criteria leading to the recommendation (e.g., RSSI, load, or any other suitable criteria), or any other suitable information.

In an embodiment, the AP roaming service further considers network characteristics, as discussed above in relation to block 302 and below in relation to FIG. 4. Alternatively, the AP roaming service considers the counter proposal from the STA roaming service and the existing roam point, without re-considering the network characteristics. The flow then proceeds to block 304, where the AP roaming service sends the updated roam point parameters to the STA MLD. In an embodiment, the negotiation between the AP MLD and the non-AP STA MLD continues (e.g., with proposals and counter-proposals) until the proposed parameters converge.

FIG. 4 is a flowchart illustrating an AP MLD determining a roam point, according to one embodiment. In an embodiment, FIG. 4 corresponds with block 302 illustrated in FIG. 3. At block 402, an AP roaming service for an AP MLD (e.g., the AP roaming service 212 illustrated in FIG. 2) monitors network conditions. At block 404, the AP roaming service monitors application quality of service (QOS) performance. At block 406, the AP roaming service monitors characteristics relating one or more STA contracts (e.g., stream classification service (SCS) characteristics, restricted target wake time (rTWT), or any other suitable contractual characteristics), or any other suitable characteristics. These are merely examples, and the AP roaming service can monitor any suitable network conditions or other information.

At block 408, the AP roaming service determines a roam point. In an embodiment, the AP roaming service determines a preferred roam point for the non-AP STA, based on the characteristics. The preferred roam point can be an optimal roam point, or any other preferred roam point. Further, the roam point can be a proposed time to roam (e.g., expressed in TSF time for the associated AP MLD), a SN (e.g., a per-TID SN) to roam, or any other suitable roam point. Further, in one embodiment the AP roaming service identifies a roam point for all the non-AP STA MLD links (e.g., to minimize or reduce handoff disruption). Alternatively, or in addition, the AP roaming service identifies a roam point for a subset of the non-AP STA MLD links (e.g., one or more, but not all, of the non-AP STA MLD links).

Additionally, in an embodiment the non-AP STA can roam for all TIDs. Alternatively, or in addition, the non-AP STA can roam for a subset of TIDs (e.g., one or more, but not all, TIDs). Further, in some circumstances the devices in the network (e.g., individual AP MLDs) will have synchronized time, allowing the AP MLD coordinating roaming to have a TSF. This can allow the same TSF value to be used on multiple links for more accurate and precise roaming handoff.

Further, in an embodiment the AP roaming service uses one or more suitable machine learning (ML) models to determine a roam point. For example, a supervised ML model (e.g., a neural network, including a deep learning neural network (DNN), or any other suitable supervised ML model) can be trained using historical acceptances and rejections of roam point proposals to identify improved roam point proposals. Further, the ML model could be trained using historical outcomes of roaming (e.g., modulation coding scheme (MCS), packet error rate (PER), throughput, duration of the association to the target AP MLD, or any other suitable outcomes) to identify improved roam point proposals.

FIG. 5 is a flowchart 500 illustrating non-AP STA initiated coordinated roaming for MLDs, according to one embodiment. In an embodiment, FIG. 3, above, illustrates AP initiated coordinated roaming for MLDs, while FIG. 5 illustrates STA initiated coordinated roaming for MLDs. These are merely examples, and any suitable network component can initiate coordinated roaming for MLDs.

At block 502, an STA roaming service for a non-AP STA MLD (e.g., the STA roaming service 262 illustrated in FIG. 2) determines a roam point for one or more MLD links. In an embodiment, the STA roaming service uses its link conditions, roaming capabilities, or any other suitable information to identify a roam point. Further, the STA roaming service can identify a roam point for all the non-AP STA MLD links (e.g., to minimize or reduce handoff disruption). Alternatively, or in addition, the STA roaming service identifies a roam point for a subset of the non-AP STA MLD links (e.g., one or more, but not all, of the non-AP STA MLD links). Additionally, in an embodiment the non-AP STA can roam for all TIDs. Alternatively, or in addition, the non-AP STA can roam for a subset of TIDs (e.g., one or more, but not all, TIDs). This is discussed further, above, with regard to FIG. 4, as well as below with regard to block 510.

At block 504, the STA roaming service (e.g., the STA roaming service for an STA MLD) sends roam point parameters to the AP MLD. As discussed above in relation to block 304 illustrated in FIG. 3, in one embodiment the STA roaming service sends the roam point parameters in an existing management frame. Alternatively, or in addition, the STA roaming service sends the roam point parameters using a new management frame (e.g., a new management frame defined for MLD roaming coordination). These are merely examples, and the STA roaming service can send the roam point parameters using any suitable technique.

At block 506, an AP roaming service for an AP MLD (e.g., the AP roaming service 212 illustrated in FIG. 2) determines whether to accept the proposed roam point from the non-AP STA MLD. In an embodiment, the AP roaming service assesses the proposed roam point against network conditions, roaming capabilities, or any other suitable criteria, to determine acceptance.

In an embodiment, the AP roaming service responds to the STA MLD indicating acceptance or rejection of the proposed roam point. If the AP roaming service accepts the roam point, the AP roaming service responds to the non-AP STA MLD indicating acceptance and the flow proceeds to block 508. If the AP roaming service rejects the roam point, the AP roaming service responds to the non-AP STA MLD indicating rejection and the flow proceeds to block 512.

At block 508, the AP roaming service and the STA roaming service coordinate the roaming transition. As discussed above in relation to block 308 illustrated in FIG. 3, in an embodiment the AP roaming service and the STA roaming service coordinate to transition the transmission and reception of traffic to the target AP MLD or target AP, at the negotiated roam point.

At block 510, the STA MLD roams to the target (e.g., the target AP or AP MLD) at the roam point. As discussed above, the STA MLD transitions from the source AP MLD to the target, at the roam point. The STA MLD can transition all links, or a subset of links. Further, the STA MLD can transition all TIDs, or a subset of TIDs. The flow then ends.

As discussed above, in an embodiment an AP MLD and STA MLD can coordinate a roam point for all TIDs or a subset of TIDs, and for all links or a subset of links. In an embodiment, the roam point can be implemented independently on a per-TID basis (e.g., to account for different application needs). For example, the AP MLD and STA MLD can coordinate different roam points for different TIDs or different groups of TIDs. Further, the AP MLD, STA MLD, or both, can use TID to link mapping to constrain traffic on each link (e.g., constrain one or more TIDs or groups of TIDs to a give link).

Returning to block 512, if the AP roaming service rejects to the proposed roam point, in an embodiment the AP roaming service sends a counter proposal to the non-AP STA MLD. For example, the AP roaming service can use network conditions to modify the proposed roam point. The AP roaming service can then send the counter proposal to the non-AP STA MLD.

At block 514, the STA roaming service determines an updated roam point. For example, the STA roaming service can use the counter-proposal from the AP roaming service to determine an updated roam point. The updated roam point can include any suitable roam point information, as discussed above in relation to block 314 illustrated in FIG. 3.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying a negotiated roam point for one or more links of a wireless station (STA) multi-link device (MLD) to roam from a source wireless access point (AP) MLD to a target AP;
coordinating roaming for the one or more links of the STA MLD from the source AP MLD to the target AP, based on the negotiated roam point, comprising:
preparing, prior to the negotiated roam point, to transition traffic for the one or more links from the source AP MLD to the target AP; and
transitioning the one or more links of the STA MLD from the source AP MLD to the target AP using the negotiated roam point.

2. The method of claim 1, further comprising:
negotiating the roam point for the one or more links of the STA MLD, comprising:
determining, at a first AP MLD, a first proposed roam point for the one or more links of the STA MLD;
transmitting the first proposed roam point from the first AP MLD to the STA MLD; and
receiving at the first AP MLD a response from the STA MLD indicating at least one of acceptance or rejection of the proposed roam point.

3. The method of claim 2, wherein the response indicates rejection of the proposed roam point, the method further comprising:
receiving at the first AP MLD from the STA MLD a counter-proposal relating to the roam point; and
determining a second roam point based on the counter-proposal.

4. The method of claim 2, wherein the first AP MLD determines the first proposed roam point based on one or more network characteristics.

5. The method of claim 4, wherein the one or more network characteristics comprise at least one of: (i) network conditions, (ii) application quality of service (QOS) performance, or (iii) STA contract characteristics including at least one of: (a) stream classification service (SCS) QoS characteristics, (b) target wake time (TWT), or (c) restricted TWT.

6. The method of claim 1, further comprising:
negotiating the roam point for the one or more links of the STA MLD, comprising:
determining, at the STA MLD, a first proposed roam point for the one or more links of the STA MLD;
transmitting the first proposed roam point from the STA MLD to a first AP MLD; and
receiving at the STA MLD a response from the first AP MLD indicating at least one of acceptance or rejection of the proposed roam point.

7. The method of claim 1, wherein the STA MLD comprises a plurality of links to one or more APs, and wherein the roam point relates to all of the plurality of links.

8. The method of claim 1, wherein the STA MLD comprises a plurality of links to one or more APs, and wherein the roam point relates to at least one, but not all, of the plurality of links.

9. The method of claim 1, wherein the roam point relates to at least one, but not all, traffic identifiers (TIDs) for traffic relating to the STA MLD.

10. The method of claim 1, wherein the negotiated roam point comprises at least one of: (i) a time or (ii) a sequence number (SN).

11. A system, comprising:
one or more processors; and
one or more memories storing a program, which, when executed on any combination of the one or more processors, performs operations, the operations comprising:
identifying a negotiated roam point for one or more links of a wireless station (STA) multi-link device (MLD) to roam from a source wireless access point (AP) MLD to a target AP;
coordinating roaming for the one or more links of the STA MLD from the source AP MLD to the target AP, based on the negotiated roam point, comprising:
preparing, prior to the negotiated roam point, to transition traffic for the one or more links from the source AP MLD to the target AP; and
transitioning the one or more links of the STA MLD from the source AP MLD to the target AP using the negotiated roam point.

12. The system of claim 11, the operations further comprising:
negotiating the roam point for the one or more links of the STA MLD, comprising:
determining, at a first AP MLD, a first proposed roam point for the one or more links of the STA MLD;
transmitting the first proposed roam point from the first AP MLD to the STA MLD; and
receiving at the first AP MLD a response from the STA MLD indicating at least one of acceptance or rejection of the proposed roam point.

13. The system of claim 12, wherein the response indicates rejection of the proposed roam point, the operations further comprising:
receiving at the first AP MLD from the STA MLD a counter-proposal relating to the roam point; and
determining a second roam point based on the counter-proposal.

14. The system of claim 11, the operations further comprising:
negotiating the roam point for the one or more links of the STA MLD, comprising:
determining, at the STA MLD, a first proposed roam point for the one or more links of the STA MLD;
transmitting the first proposed roam point from the STA MLD to a first AP MLD; and
receiving at the STA MLD a response from the first AP MLD indicating at least one of acceptance or rejection of the proposed roam point.

15. The system of claim 11, wherein at least one of:
(i) the STA MLD comprises a plurality of links to one or more APs, and the roam point relates to at least one, but not all, of the plurality of links, or
(ii) the roam point relates to at least one, but not all, traffic identifiers (TIDs) for traffic relating to the STA MLD.

16. A non-transitory computer-readable medium containing computer program code that, when executed by operation of one or more computer processors, performs operations comprising:
identifying a negotiated roam point for one or more links of a wireless station (STA) multi-link device (MLD) to roam from a source wireless access point (AP) MLD to a target AP;
coordinating roaming for the one or more links of the STA MLD from the source AP MLD to the target AP, based on the negotiated roam point, comprising:
preparing, prior to the negotiated roam point, to transition traffic for the one or more links from the source AP MLD to the target AP; and
transitioning the one or more links of the STA MLD from the source AP MLD to the target AP using the negotiated roam point.

17. The non-transitory computer-readable medium of claim 16, the operations further comprising:
negotiating the roam point for the one or more links of the STA MLD, comprising:
determining, at a first AP MLD, a first proposed roam point for the one or more links of the STA MLD;
transmitting the first proposed roam point from the first AP MLD to the STA MLD; and
receiving at the first AP MLD a response from the STA MLD indicating at least one of acceptance or rejection of the proposed roam point.

18. The non-transitory computer-readable medium of claim 17, wherein the response indicates rejection of the proposed roam point, the operations further comprising:
receiving at the first AP MLD from the STA MLD a counter-proposal relating to the roam point; and
determining a second roam point based on the counter-proposal.

19. The non-transitory computer-readable medium of claim 16, the operations further comprising:
negotiating the roam point for the one or more links of the STA MLD, comprising:
determining, at the STA MLD, a first proposed roam point for the one or more links of the STA MLD;
transmitting the first proposed roam point from the STA MLD to a first AP MLD; and
receiving at the STA MLD a response from the first AP MLD indicating at least one of acceptance or rejection of the proposed roam point.

20. The non-transitory computer-readable medium of claim 16, wherein at least one of:
(i) the STA MLD comprises a plurality of links to one or more APs, and the roam point relates to at least one, but not all, of the plurality of links, or
(ii) the roam point relates to at least one, but not all, traffic identifiers (TIDs) for traffic relating to the STA MLD.
